(19) United States
(12) Patent Application Publication
(10) Pub. No.: US 2016/0062180 A1
(43) Pub. Date: Mar. 3, 2016

(54) COLOR FILTER COMPOSITION AND LIQUID CRYSTAL DISPLAY INCLUDING THE SAME

(71) Applicant: SAMSUNG DISPLAY CO., LTD., Yongin-City (KR)

(72) Inventors: Hi Kuk LEE, Yongin-si (KR); Tsunemitsu TORIGOE, Hwaseong-si (KR); Chang Hoon KIM, Asan-si (KR); Ki Beom LEE, Seoul (KR); Su-Yeon SIM, Seoul (KR); Sang Hyun LEE, Suwon-si (KR)

(21) Appl. No.: 14/804,480

(22) Filed: Jul. 21, 2015

(30) Foreign Application Priority Data
Aug. 27, 2014 (KR) 10-2014-0112422

(51) Int. Cl. G02F 1/1335; G02F 1/1362; G02F 1/1368

(52) U.S. Cl. CPC G02F 1/133514; G02F 1/1368; G02F 1/136286; G02F 1/136227

(57) ABSTRACT

A color filter composition includes a mill base including a pigment, an initiator, and a solvent. The initiator is a compound including an oxime group and a light absorbance unit, as expressed in Formula 1.

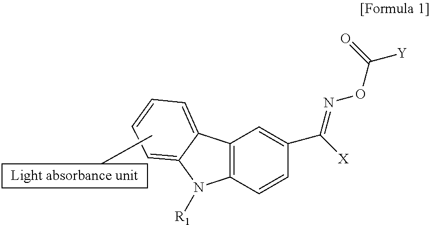

In Formula 1, X, Y, and R1 are identical to or different from each other and are independently a C1 to C12 alkyl based group or a phenyl based group. The light absorbance unit includes at least one of an acetophenone based group, a benzoin based group, a benzophenone based group, and a triazine based group.

### CROSS-REFERENCE TO RELATED APPLICATION

Korean Patent Application No. 10-2014-0112422 filed on Aug. 27, 2014, in the Korean Intellectual Property Office, and entitled: “Color Filter Composition and Liquid Crystal Display Including the Same,” is incorporated by reference herein in its entirety.

### BACKGROUND

1. Field

Embodiments relate to a color filter composition and a liquid crystal display including the same.

2. Description of the Related Art

In general, a flat panel display, as a display device that is widely used, includes various kinds, such as a liquid crystal display (LCD) and an organic light emitting diode (OLED) display.

Among them, the liquid crystal display is a display device which includes a liquid crystal layer interposed between two sheets of display substrates, each including a field generating electrode. When voltages are applied to the electrodes, liquid crystal molecules of the liquid crystal layer are rearranged, thereby controlling transmittance of light passing through the liquid crystal layer.

Here, a scanning signal wire or gate wire for transmitting a scanning signal and an image signal line or data wire for transmitting an image signal may be formed on one of the two display substrates. The display substrate may include a thin film transistor array panel configured with a thin film transistor connected to the gate wire and the data wire and a pixel electrode connected to the thin film transistor.

### SUMMARY

Embodiments are directed to a color filter composition including a mill base including a pigment, an initiator, and a solvent. The initiator is a compound including an oxime group and a light absorbance unit, as expressed in Formula 1:

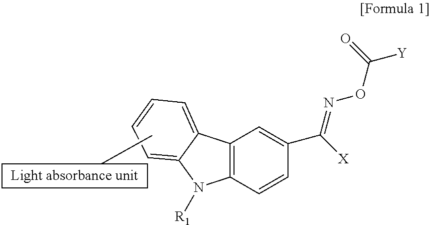

In Formula 1, X, Y, and R₁ are identical to or different from each other and are independently a C1 to C12 alkyl based group or a phenyl based group. The light absorbance unit includes at least one of an acetophenone based group, a benzoin based group, a benzophenone based group, and a triazine based group.

The light absorbance unit may include the acetophenone based group. The acetophenone based group may include at least one of 4-phenoxydichloroacetophenone, 4-t-butyl-dichloroacetophenone, diethoxyacetophenone, 1-(4-isopropyl phenyl)-2-hydroxy-2-methyl propane)-1-one, and 1-hydroxycyclohexyl phenyl ketone.

The light absorbance unit includes the benzoin based group. The benzoin based group may include at least one of benzoin, benzoin methyl ether, benzoin isopropyl ether, and benzyl dimethyl ketal.

The light absorbance unit may include the benzophenone based group. The benzophenone based group may include at least one of 4-phenyl benzophenone, hydroxybenzophenone, and 4-benzoyl-4′-methyl diphenyl sulfide.

The light absorbance unit may include the triazine based group. The triazine based group may include at least one of 2,4,6-trichloro-s-triazine, 2-phenyl-4,6-bis(trichloromethyl)-s-triazine, 2-(p-methoxyphenyl)-4,6-bis(trichloromethyl)-s-triazine, 2-(p-tolyl)-4,6-bis(trichloromethyl)-s-triazine, 2-piperonyl-4,6-bis(trichloromethyl)-s-triazine, 2,4-bis(trichloromethyl)-6-styryl-s-triazine, and 2-(4-methoxy-naphtho-1-yl)-4,2-(naphtho-1-yl)-4,6-bis(trichloromethyl)-s-triazine.

The color filter composition may further include a sensitizer in an amount of about 0.1 wt % to about 0.9 wt % of the color filter composition. The sensitizer may include at least one of a benzophenone derivative, a thioxanthone derivative, xanthene, cyanine, thiazine, acridine, an anthraquinone, phenazine, an azo compound, diphenylmethane, triphenylmethane, distyryl benzene, carbazole, porphyrin, a spiro compound, quinacridone, indigo, a styryl compound, a pyrazolo triazole compound, a benzothiazole compound, a barbituric acid derivative, a thiobarbituric acid derivative, acetophenone, and a heterocyclic compound.

The color filter composition may further include a resin that includes a polymerization inhibiting agent and a storage stabilizing agent.

The polymerization inhibiting agent may include at least one of hydroquinone, p-methoxyphenol, di-tert-butyl-p-cresol, pyrogallol, t-butyl catechol, benzoquinone, 4,4′-thiobis(3-methyl-6-t-butylphenol), n-nitroso phenyl hydroxylamine, phenoxazine, phenothiazine, and a cerium (I) salt.

The storage stabilizing agent may include at least one of benzyl trimethyl chloride, diethyl hydroxyamine hydrochloride, ammonium chloride, lactic acid, oxalic acid, a methyl ester of an organic acid, t-butyl pyrocatechol, tetraethyl phosphine, tetraphenyl phosphine, organic phosphine, and a sub-phosphate.

The color filter composition may further include a surfactant and an adherence reinforcing agent.

The surfactant may include a fluorine-based surfactant expressed in Formula 2 and a polysiloxane based surfactant expressed in Formula 3:

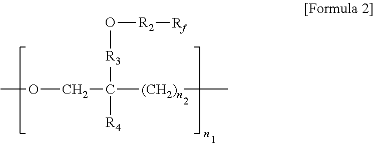

In Formula 2, R₂ and R₃ are identical to or different from each other and are independently a C1 to C5 alkylene group, R₄ is a hydrogen atom or a C1 to C5 alkyl group, R_{f} is a fluorinated C1 to C6 alkyl group, n₁ is 1 to 50, and n₂ is 0 or 1.

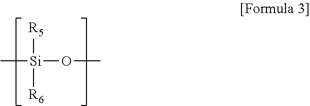

In Formula 3, R₅ is a straight or branched C1 to C3 alkyl group, and R₆ is a straight or branched C1 to C15 alkyl group.

The adherence reinforcing agent may include a coupling agent or a melamine crosslinking agent.

The adherence reinforcing agent may include the coupling agent. The coupling agent may include a vinyl silane coupling agent or an epoxy silane coupling agent.

Embodiments are also directed to a liquid crystal display including a substrate, a gate line on the substrate, the gate line including a gate electrode, a gate insulating layer on the gate line, a semiconductor on the gate insulating layer, a data line on the semiconductor, the data line including a source electrode, a drain electrode on the semiconductor, the drain electrode facing the source electrode, a passivation layer on the gate insulating layer, the data line, and the drain electrode, a color filter on the passivation layer, a contact hole on the color filter and the passivation layer, the contact hole exposing the drain electrode, and a pixel electrode on the color filter, the pixel electrode being connected to the drain electrode through the contact hole. The color filter may be formed from a color filter composition including a mill base including a pigment, an initiator, and a solvent. The initiator is a compound including an oxime group and a light absorbance unit as expressed in Formula 1:

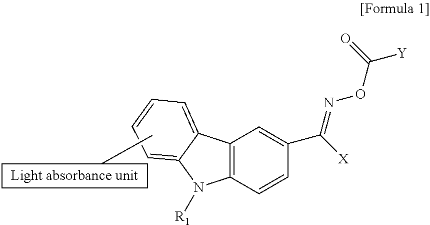

In Formula 1, X, Y, and R₁ are identical to or different from each other and are independently a C1 to C12 alkyl based group or a phenyl based group. The light absorbance unit includes at least one of an acetophenone group, a benzoin group, a benzophenone group, and a triazine based group.

The color filter composition may further include a sensitizer in an amount of about 0.1 wt % to about 0.9 wt % of the color filter composition. The sensitizer may include at least one of a benzophenone derivative, a thioxanthone derivative, xanthene, cyanine, thiazine, acridine, an anthraquinone, phenazine, an azo compound, diphenylmethane, triphenylmethane, distyryl benzene, carbazole, porphyrin, a spiro compound, quinacridone, indigo, a styryl compound, a pyrazolo triazole compound, a benzothiazole compound, a barbituric acid derivative, a thiobarbituric acid derivative, acetophenone, and a heterocyclic compound.

The color filter composition may further include a resin that includes a polymerization inhibiting agent and a storage stabilizing agent.

The polymerization inhibiting agent may include at least one of hydroquinone, p-methoxyphenol, di-tert-butyl-p-cresol, pyrogallol, t-butyl catechol, benzoquinone, 4,4′-thiobis(3-methyl-6-t-butylphenol), n-nitroso phenyl hydroxylamine, phenoxazine, phenothiazine, and a cerium (I) salt.

The storage stabilizing agent may include at least one of benzyl trimethyl chloride, diethyl hydroxyamine hydrochloride, ammonium chloride, lactic acid, oxalic acid, a methyl ester of an organic acid, t-butyl pyrocatechol, tetraethyl phosphine, tetraphenyl phosphine, organic phosphine, and a sub-phosphate.

The color filter composition may further includes a surfactant and an adherence reinforcing agent

The surfactant may include a fluorine-based surfactant expressed in Formula 2 and a polysiloxane based surfactant expressed in Formula 3:

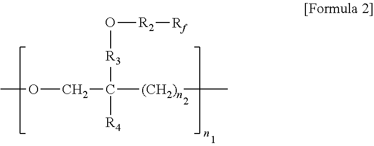

In Formula 2, R² and R₃ are identical to or different from each other and are independently a C1 to C5 alkylene group, R₄ is a hydrogen atom or a C1 to C5 alkyl group, R_{f} is a C1 to C6 fluorinated alkyl group, n₁ is 1 to 50, and n₂ is 0 or 1.

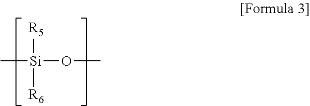

In Formula 3, R₅ is a straight or branched C1 to C3 alkyl group, and R₆ is a straight or branched C1 to C15 alkyl group.

The adherence reinforcing agent may include a coupling agent or a melamine crosslinking agent.

The adherence reinforcing agent may include the coupling agent. The coupling agent may include a vinyl silane coupling agent or an epoxy silane coupling agent.

### BRIEF DESCRIPTION OF THE DRAWINGS

Features will become apparent to those of skill in the art by describing in detail exemplary embodiments with reference to the attached drawings in which:

FIG. 1 illustrates a graph of absorbance according to a wavelength of light when a color filter is formed with a color filter composition including a general initiator.

FIG. 2 to FIG. 4 illustrate graphs of absorbance according to a wavelength of light when a color filter is formed with a color filter composition including an initiator according to an exemplary embodiment.

FIG. 5 illustrates a case of patterning a color filter when a color filter is formed by using a color filter composition according to an exemplary embodiment.

FIG. 6 illustrates a layout view of a liquid crystal display according to an exemplary embodiment.

FIG. 7 illustrates a cross-sectional view with respect to a line VII-VII of FIG. 6.

FIG. 8 illustrates a cross-sectional view with respect to a line VIII-VIII of FIG. 6.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “between” two layers, it can be the only layer between the two layers, or one or more intervening layers may also be present. Like reference numerals refer to like elements throughout.

A color filter composition according to an exemplary embodiment may include a mill base, an initiator, a sensitizer, a resin, an additive, and a solvent. The mill base may include a pigment, a pigment dispersant, and a solvent.

The color filter composition may increase the absorption rate of light with a wavelength of about 405 nm. A taper angle may be controlled within the range of 10 to 80 degrees when the color filter composition is patterned after it is hardened.

The initiator may increase the absorption rate of light with a wavelength of about 405 nm. The initiator may include an oxime group and a light absorbance unit. An amount of 1 wt % to 50 wt % of the initiator may be included in the color filter composition with respect to monomers.

The initiator may include a compound expressed in Formula 1.

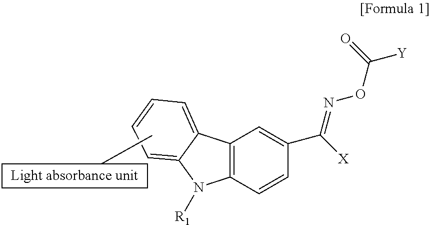

In Formula 1, X, Y, and R₁ are identical to or different from each other, and are independently C1 to C12 alkyl based group or a phenyl based group.

The light absorbance unit may include at least one of an acetophenone group, a benzoin group, a benzophenone group, and a triazine based group.

The acetophenone based group may include at least one of 4-phenoxydichloroacetophenone, 4-t-butyl-dichloroacetophenone, diethoxyacetophenone, 1-(4-isopropyl phenyl)-2-hydroxy-2-methyl propane)-1-one, and 1-hydroxycyclohexyl phenyl ketone.

The benzoin based group may include at least one of benzoin, benzoin methyl ether, benzoin isopropyl ether, and benzyl dimethyl ketal.

The benzophenone based group may include at least one of 4-phenyl benzophenone, hydroxybenzophenone, and 4-benzoyl-4′-methyl diphenyl sulfide.

The triazine based group may include at least one of 2,4,6-trichloro-s-triazine, 2-phenyl-4,6-bis(trichloromethyl)-s-triazine, 2-(p-methoxyphenyl)-4,6-bis(trichloromethyl)-s-triazine, 2-(p-tolyl)-4,6-bis(trichloromethyl)-s-triazine, 2-piperonyl-4,6-bis(trichloromethyl)-s-triazine, 2,4-bis(trichloromethyl)-6-styryl-s-triazine, and 2-(4-methoxy-naphtho-1-yl)-4,2-(naphtho-1-yl)-4,6-bis(trichloromethyl)-s-triazine.

The sensitizer may increase the light absorption rate of the color filter composition. Further, the color filter composition may be hardened to form a color filter such that the taper angle may be controlled within the range of 10 to 80 degrees when a contact hole is formed. The sensitizer may include at least one of a benzophenone derivative, a thioxanthone derivative, xanthene, cyanine, thiazine, acridine, anthraquinones, phenazine, an azo compound, diphenylmethane, triphenylmethane, distyryl benzene, carbazole, porphyrin, a spiro compound, quinacridone, indigo, a styryl compound, a pyrazolo triazole compound, a benzothiazole compound, a barbituric acid derivative, a thiobarbituric acid derivative, acetophenone, and a heterocyclic compound.

The benzophenone derivative may include at least one of benzophenone, dibenzosuberone, benzoyl benzoic acid, benzoyl benzoic acid methyl, 4-phenyl benzophenone, hydroxybenzophenone, 4-benzoyl-4′-methyl diphenyl sulfide, 3,3′-dimethyl-4-methoxybenzophenone, 2,4-dichlorobenzophenone, and 2,4′-dichlorobenzophenone.

The thioxanthone derivative may include at least one of thioxanthone, 2-chlorothioxanthone, 2-methyl thioxanthone, 2,4-dimethylthioxanthone, isopropylthioxanthone, 2,4-dichlorothioxanthone, 2,4-diethyl thioxanthone, and 2,4-diisopropyl thioxanthone.

The xanthene may include at least one of fluorescein, eosin, erythrocin, Rhodamine B, and Rose Bengal.

The cyanine may include at least one of thiacarbocyanine, oxacarbocyanine, merocyanine, and phthalocyanine.

The thiazine may include at least one of thionine, methylene blue, and toluidine blue.

The acridine may include at least one of acridine orange, chloroflavin, and acriflavine.

The resin may include a polymerization inhibiting agent and a storage stabilizing agent.

The polymerization inhibiting agent may prevent undesired thermal polymerization of a polymerized compound while the color filter composition is preserved. The polymerization inhibiting agent may include at least one of hydroquinone, p-methoxyphenol, di-tert-butyl-p-cresol, pyrogallol, t-butyl catechol, benzoquinone, 4,4′-thiobis(3-methyl-6-t-butylphenol), n-nitroso phenyl hydroxylamine, phenoxazine, phenothiazine, and a cerium (I) salt.

The storage stabilizing agent may increase the stability of the color filter composition when the color filter composition is preserved for a long time. The storage stabilizing agent may include at least one of benzyl trimethyl chloride, diethyl hydroxyamine hydrochloride, ammonium chloride, lactic acid, oxalic acid, a methyl ester of an organic acid, t-butyl pyrocatechol, tetraethyl phosphine, tetraphenyl phosphine, an organic phosphine, and a sub-phosphate.

The additive may include a surfactant and an adherence reinforcing agent.

The surfactant may reduce surface tension to form a uniform film when the color filter composition is coated. The surfactant may be a mixture of a fluorine based surfactant expressed in Formula 2 and a polysiloxane based surfactant expressed in Formula 3.

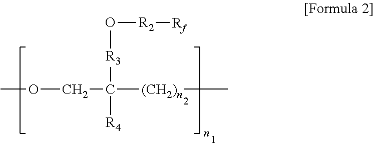

In Formula 2, R₂ and R₃ are identical to or different from each other, and are independently a C1 to C5 alkylene group.

R₄ is a hydrogen atom or a C1 to C5 alkyl group.

R₁ is a C1 to C6 fluorinated alkyl group.

n₁ is 1 to 50, and n₂ is 0 or 1.

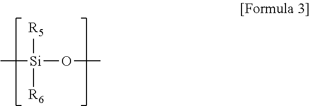

In Formula 3, R₅ is a straight or branched C1 to C3 alkyl group.

R₆ is a straight or branched C1 to C15 alkyl group.

When the color filter composition is exposed, the adherence reinforcing agent may harden the color filter composition to a bottom to prevent lifting, and may improve adherence to a lower layer. A coupling agent or a melamine crosslinking agent may be used as the adherence reinforcing agent.

The coupling agent includes a silane coupling agent such as a vinyl silane or an epoxy silane.

Here, the vinyl silane may include at least one of vinyltris(β-methoxyethoxy) silane, vinylethoxysilane, vinyltrimethoxysilane, vinyltriethoxysilane, and vinyltris(2-methoxyethoxy)silane.

The epoxy silane may include at least one of β-(3,4-epoxycyclohexyl) ethyltrimethoxysilane), (3,4-epoxycyclohexyl)methyltrimethoxysilane, β-(3,4-epoxycyclohexyl)ethyltriethoxysilane), β-(3,4-epoxycyclohexyl)methyltriethoxysilane), γ-glycidoxypropyl trimethoxysilane, γ-glycidoxypropyl triethoxysilane, n-2-aminoethyl-3-aminopropylmethyldimethoxysilane, n-(2-aminoethyl)-3-aminopropyltrimethoxy silane, 3-aminopropyltriethoxysilane, 2-(3,4-epoxycyclohexyl)ethyltrimethoxysilane, 3-chloropropylmethyldimethoxysilane, 3,3-chloropropyltrimethoxysilane, and 3-mercaptopropyltrimethoxysilane.

The solvent may include at least one of ethylene glycol monomethyl ether, ethylene glycol monoethyl ether, ethylene glycol monopropyl ether, ethylene glycol monobutyl ether, diethylene glycol monomethyl ether, diethylene glycol monoethyl ether, diethylene glycol monopropyl ether, diethylene glycol monobutyl ether, triethylene glycol monomethyl ether, triethylene glycol monoethyl ether, propylene glycol monomethyl ether, propylene glycol monoethyl ether, propylene glycol monopropyl ether, propylene glycol monobutyl ether, dipropylene glycol monomethyl ether, dipropylene glycol monoethyl ether, dipropylene glycol monopropyl ether, dipropylene glycol monobutyl ether, tripropylene glycol monomethyl ether, tripropylene glycol monoethyl ether, ethylene glycol monomethyl ether acetate, ethylene glycol monoethyl ether acetate, diethylene glycol monomethyl ether acetate, diethylene glycol monoethyl ether acetate, propylene glycol monomethyl ether acetate, propylene glycol monoethyl ether acetate, 3-methoxybutyl acetate, 3-methyl-3-methoxybutyl acetate, diethylene glycol dimethyl ether, diethylene glycol methylethyl ether, diethylene glycol diethyl ether, tetrahydrofuran, methyl ethyl ketone, cyclohexanone, 2-heptanone, 3-heptanone propylene glycol diacetate, 1,3-butylene glycol diacetate, 1,6-hexanediol diacetate, lactic acid methyl ester, lactic acid ethyl ester, 2,2-hydroxy methyl propionate ethyl, 3-methoxy propionate methyl, 3-methoxy propionate ethyl, 3-ethoxy propionate methyl, 3-ethoxy propionate ethyl, ethoxyethyl acetate, hydroxy ethyl acetate, 2,3-hydroxy methyl butanoic acid methyl, ethyl acetate, acetic acid n-propyl, acetic acid i-propyl, acetic acid n-butyl, acetic acid i-butyl, acetic acid n-amyl, acetic acid i-amyl, propionate n-butyl, ethyl butyrate, butyric acid n-propyl, butyric acid i-propyl, butyric acid n-butyl, pyruvate methyl, pyruvic acid ethyl, pyruvic acid n-propyl, acetoacetic acid methyl, acetoacetic acid ethyl, 2-oxobutanoic acid ethyl, formic acid amyl, oxymethyl acetate, oxyethyl acetate, oxybutyl acetate, methoxymethyl acetate, methoxyethyl acetate, methoxybutyl acetate, ethoxymethyl acetate, 3,3-ethoxyethyl acetate, oxypropionic acid methyl, 3-oxypropionate, 3-ethylmethoxy propionate methyl, 3-methoxy propionic acid ethyl, 3-ethoxy propionic acid methyl, and 3-ethoxy propionic acid ethyl.

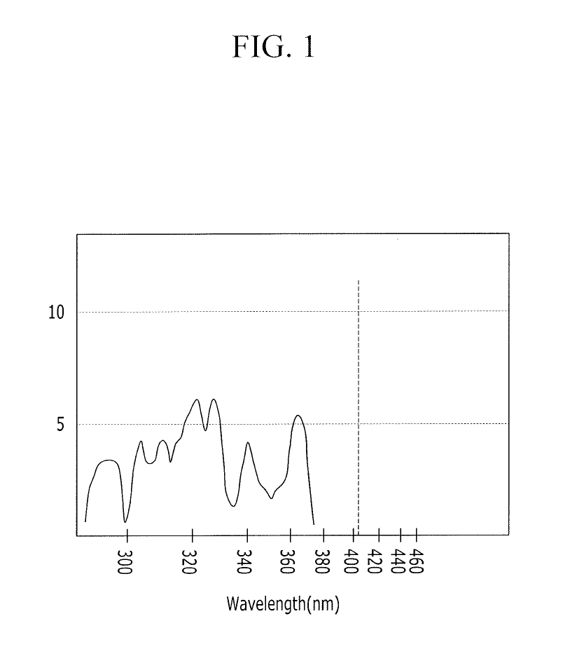

A characteristic of a color filter composition according to an exemplary embodiment will now be described with reference to FIG. 1 to FIG. 5.

FIG. 1 illustrates a graph of absorbance according to a wavelength of light when a color filter is formed with a color filter composition including a general initiator. Here, the general initiator is a known initiator that does not include a light absorbance unit according to an exemplary embodiment.

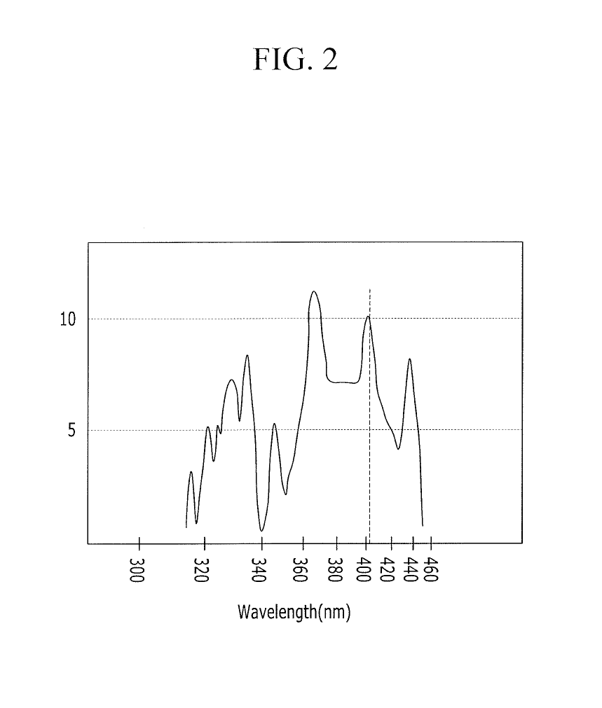

FIG. 2 to FIG. 4 illustrate graphs of absorbance according to a wavelength of light when a color filter is formed with a color filter composition including an initiator according to an exemplary embodiment.

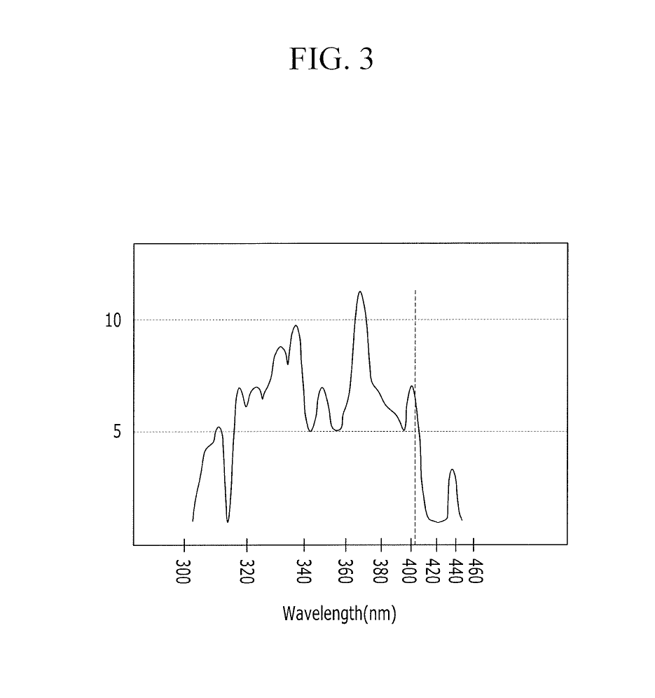

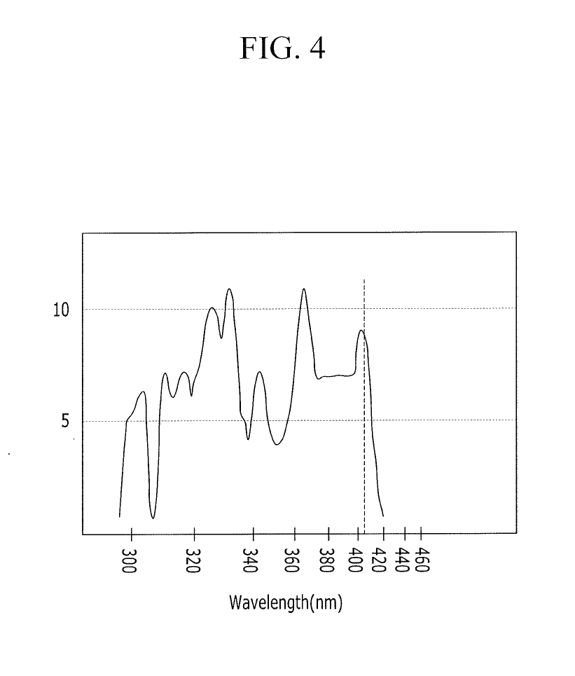

FIG. 2 illustrates a graph of absorbance according to a wavelength of light for a red color filter, FIG. 3 illustrates a graph of absorbance according to a wavelength of light for a green color filter, and FIG. 4 illustrates a graph of absorbance according to a wavelength of light for a blue color filter.

Referring to FIG. 1 to FIG. 4, it is shown that the color filter configured with a color filter composition including a general initiator does not show absorbance when the wavelength of the light is about 405 nm. In contrast, the color filter formed with a color filter composition including an initiator according to an exemplary embodiment shows a numerical value of the absorbance when the wavelength of the light is about 405 nm.

Referring to FIG. 1 to FIG. 4, it is shown that the color filter configured with the color filter composition including an initiator according to an exemplary embodiment has a greater light absorption rate at the wavelength of about 405 nm than the color filter formed with the color filter composition including a general initiator.

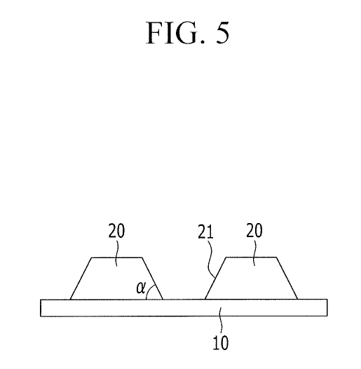

FIG. 5 illustrates a case of patterning a color filter when a color filter is formed by using a color filter composition according to an exemplary embodiment.

Referring to FIG. 5, a color filter 20 may be formed on a target substrate 10 which is then patterned to form a hole 21.

The color filter was formed by using the color filter composition according to the present exemplary embodiment. In this instance, a content of the initiator was fixed to be 2 wt % and a content of the sensitizer is changed to be 0.1 wt %, 0.3 wt %, 0.5 wt %, 0.9 wt %, and 1.0 wt % to form a color filter.

Further, the light with the 405 nm wavelength was used for the exposure for patterning the color filter.

An angle (α) between an inclined side of the color filter 20 and the target substrate 10 is referred to as a taper angle in the hole 21.

Absorbance of the color filter according to a content of the sensitizer and the taper angle are expressed in Table 1.

TABLE 1

| Sensitizer inclusion rate | 405 nm mol absorbance | Taper angle |
|---|---|---|
| (wt %) | (L/mol · cm) | (degrees) |
| 0.1 | 170 | 25 |
| 0.3 | 289 | 43 |
| 0.5 | 385 | 58 |
| 0.9 | 545 | 80 |
| 1.0 | 580 | 85 |

Referring to Table 1, it is shown that absorbance of the color filter is increased as an inclusion rate of the sensitizer is increased. It is also shown that the taper angle becomes greater as the inclusion rate of the sensitizer is increased.

Referring to Table 1, it is shown that the sensitizer increases the absorption rate of the light with the wavelength of about 405 nm of the color filter and that the taper angle is controlled within a range of 10 to 80 degrees by changing the content of an enhancer to 0.1 wt %, 0.3 wt %, 0.5 wt %, and 0.9 wt %.

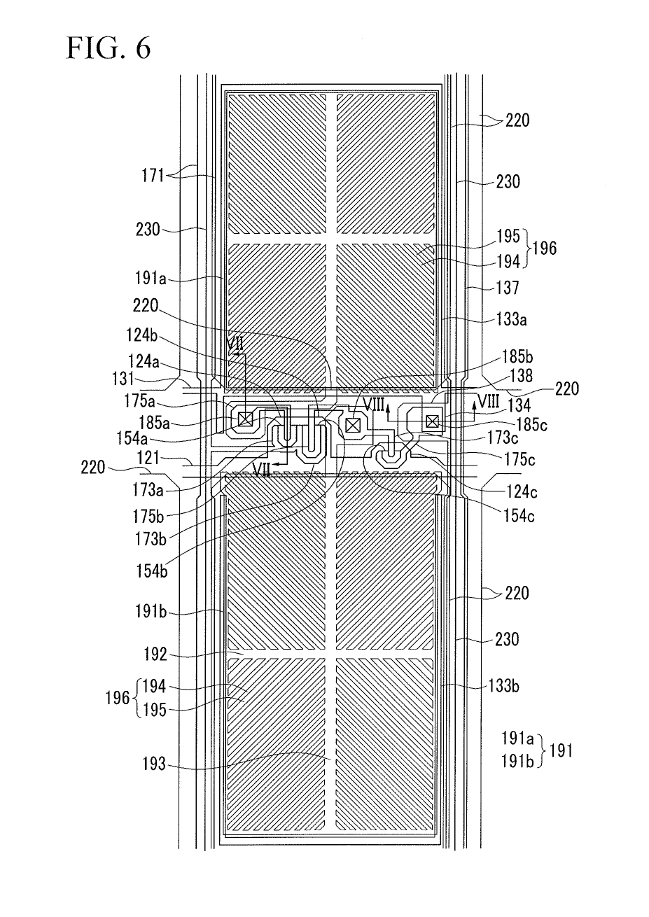

A liquid crystal display to which the above-described color filter composition may be applied according to an exemplary embodiment will now be described with reference to FIG. 6 to FIG. 8.

A liquid crystal display according to an exemplary embodiment will now be described with reference to FIG. 6 to FIG. 8.

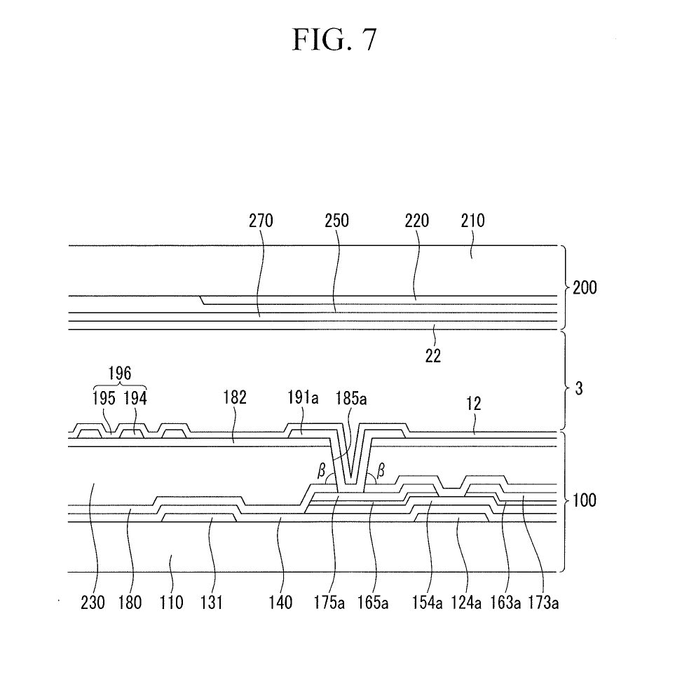

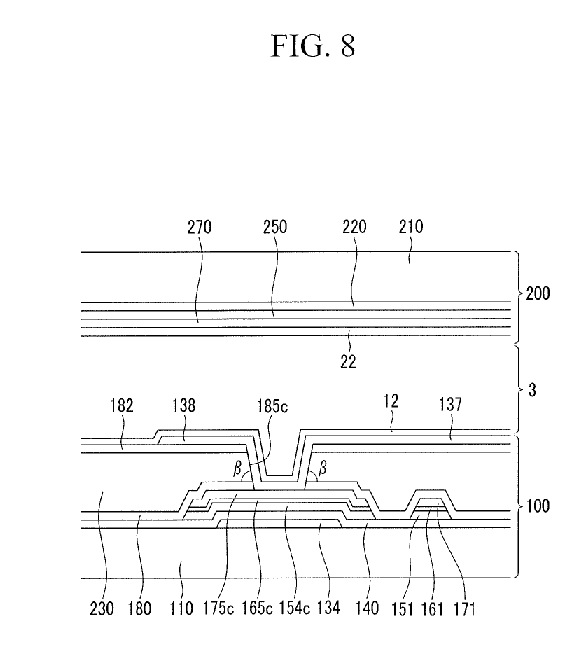

FIG. 6 illustrates a layout view of a liquid crystal display according to an exemplary embodiment, FIG. 7 illustrates a cross-sectional view with respect to a line VII-VII of FIG. 6, and FIG. 8 illustrates a cross-sectional view with respect to a line VIII-VIII of FIG. 6.

Referring to FIG. 6 to FIG. 8, the liquid crystal display may include a first display panel 100 and a second display panel 200 facing each other, and a liquid crystal layer 3 provided between the first and second display panels 100 and 200.

The first display panel 100 will now be described.

A gate line 121 and a reference voltage line 131 may be formed on a first substrate 110 made of transparent glass or plastic.

The gate line 121 may extend mainly in a horizontal direction and may transmit a gate signal. The gate line 121 may include a first gate electrode 124a, a second gate electrode 124b, and a third gate electrode 124c.

The reference voltage line 131 may extend mainly in the horizontal direction and may transmit a predetermined voltage such as a reference voltage. The reference voltage line 131 may include a first reference electrode 133a surrounding a first subpixel electrode 191a and a projection 134 protruded in a direction of the gate line 121. A second reference electrode 133b for surrounding a second subpixel electrode 191b may be disposed. Although not shown in FIG. 1, a horizontal unit of the first reference electrode 133a may be connected to a horizontal unit of the second reference electrode 133b of the previous pixel through a wire.

A gate insulating layer 140 may formed on the gate line 121 and the reference voltage line 131.

A first semiconductor 154a, a second semiconductor 154b, and a third semiconductor 154c may be formed on the gate insulating layer 140.

A plurality of ohmic contacts may be formed on the first semiconductor 154a, the second semiconductor 154b, and the third semiconductor 154c, and FIG. 7 shows ohmic contacts 163a and 165a formed on the first semiconductor 154a and FIG. 8 shows an ohmic contact 165c formed on the third semiconductor 154c, which is because the cross-sectional line is not incised.

A plurality of data lines 171 including a first source electrode 173a and a second source electrode 173b, and data conductors 171, 173c, 175a, 175b, and 175c including a first drain electrode 175a, a second drain electrode 175b, a third source electrode 173c, and a third drain electrode 175c may be formed on the ohmic contacts 163a, 165a, and 165c, and the gate insulating layer 140. The third drain electrode 175c may overlap the projection 134 of the reference voltage line 131.

The first gate electrode 124a, the first source electrode 173a, and the first drain electrode 175a may form a first thin film transistor together with the first semiconductor 154a. A channel of the first thin film transistor may be formed on a first semiconductor portion 154a between the first source electrode 173a and the first drain electrode 175a.

Similarly, the second gate electrode 124b, the second source electrode 173b, and the second drain electrode 175b may form a second thin film transistor together with the second semiconductor 154b. A channel of the second thin film transistor may be formed on the second semiconductor portion 154b between the second source electrode 173b and the second drain electrode 175b. The third gate electrode 124c, the third source electrode 173c, and the third drain electrode 175c may form a third thin film transistor together with the third semiconductor 154c. A channel of the third thin film transistor may be formed on the third semiconductor portion 154c between the third source electrode 173c and the third drain electrode 175c.

A passivation layer 180 may be formed on the data conductors 171, 173c, 175a, 175b, and 175c and the exposed semiconductor portions 154a, 154b, and 154c. The passivation layer 180 may be made of an organic insulator and has a flat surface.

The passivation layer 180 may have a dual-layer structure of a lower inorganic layer and an upper organic layer such that the passivation layer 180 may maintain an excellent insulating characteristic of the organic layer and may not damage the exposed semiconductor portions 154a, 154b, and 154c.

A color filter 230 may be disposed on the passivation layer 180. The color filter 230 may be configured with the above-described color filter composition.

A first overcoat 182 may be disposed on the color filter 230. The first overcoat 182 may be made of an inorganic material such as a silicon nitride (SiNx), a silicon oxide (SiOx) or a carbon-injected silicon oxide (SiOC). The first overcoat 182 may prevent other films from being polluted by gas generated by the color filter 230.

A first contact hole 185a, a second contact hole 185b, and a third contact hole 185c for exposing the first drain electrode 175a, the second drain electrode 175b, and the third drain electrode 175c may be formed in the passivation layer 180, the color filter 230, and the first overcoat 182.

An angle (β) between an inclined surface of the color filter 230 and the passivation layer 180 in parallel with the first substrate 110, that is, the taper angle, may be be 10 to 80 degrees in the first, second, and third contact holes 185a, 185b, and 185c.

A pixel electrode 191 including a first subpixel electrode 191a and a second subpixel electrode 191b and an auxiliary voltage line 137 may be formed on the first overcoat 182. The pixel electrode 191 and the auxiliary voltage line 137 may be made of a transparent conductive material such as ITO or IZO or a reflective metal such as aluminum, silver, chromium, or alloys thereof

The first subpixel electrode 191a may be adjacent to the second subpixel electrode 191b in a column direction. The first subpixel electrode and the second subpixel electrode may include a cross-shaped branch unit having a quadrangular shape and including a horizontal stem unit 192 and a vertical stem unit 193 crossing the horizontal stem unit 192.

The cross-shaped branch unit may be divided into four subregions by the horizontal stem unit 192 and the vertical stem unit 193. Each of the subregions may include a plurality of fine branch units 196. Each fine branch unit 196 may include a fine branch 194 and a fine slit 195.

One of the fine branch units 196 of the first subpixel electrode 191a and the second subpixel electrode 191b may be extended askew in a top left direction from the horizontal stem unit 192 or the vertical stem unit 193, and another thereof may be extended askew in a top right direction from the horizontal stem unit 192 or the vertical stem unit 193. Another thereof may be extended in a bottom left direction from the horizontal stem unit 192 or the vertical stem unit 193, and the remaining one thereof may be extended askew in a bottom right direction from the horizontal stem unit 192 or vertical stem unit 193.

Each fine branch unit 196 may form an angle of substantially 40 to 45 degrees with the gate line 121 or the horizontal stem unit 192. The fine branch unit 196 included in the first subpixel electrode 191a may form an angle of substantially 40 degrees with the horizontal stem unit 192. The fine branch unit 196 included in the second subpixel electrode 191b may form an angle of substantially 45 degrees with the horizontal stem unit 192. The fine branch units 196 of the two neighboring subregions may be orthogonal to each other.

The first subpixel electrode 191a and the second subpixel electrode 191b may be physically and electrically connected to the first drain electrode 175a and second drain electrode 175b through the contact holes 185a and 185b, and may receive data voltages from the first drain electrode 175a and the second drain electrode 175b. In this instance, part of the data voltage supplied to the second drain electrode 175b may be divided through the third source electrode 173c, and the voltage supplied to the second subpixel electrode 191b may become less than the voltage supplied to the first subpixel electrode 191a when the voltage applied to the first subpixel electrode 191a and the second subpixel electrode 191b is positive (+). When the voltage applied to the first subpixel electrode 191a and the second subpixel electrode 191b is negative (−), the voltage applied to the first subpixel electrode 191a may become less than the voltage applied to the second subpixel electrode 191b.

An area of the second subpixel electrode 191b may be equal to or greater than an area of the first subpixel electrode 191a, and may be be less than twice that of the first subpixel electrode 191a.

The auxiliary voltage line 137 may be provided on a portion that corresponds to the data line 171. The auxiliary voltage line 137 may include a connecting member 138 that extends toward the projection 134 of the reference voltage line 131. The connecting member 138 may be connected to the third drain electrode 175c through the third contact hole 185c. A reference voltage (Vest) may be applied to the projection 134 of the reference voltage line 131 such that the reference voltage (Vcst) may have a predetermined voltage value. The reference voltage (Vcst) may be applied to the third thin film transistor through the third drain electrode 175c, and the voltage applied to the second subpixel electrode 191b may be resultantly reduced.

A first alignment layer 12 may be disposed on the pixel electrode 191.

Hereinafter, the second display panel 200 will be described.

A light blocking member 220 may be disposed on a second substrate 210 made of transparent glass or plastic. The light blocking member 220 may prevent leakage of light. The light blocking member 220 may also be referred to as a black matix. In some implementations, the light blocking member 220 may be be formed on the first substrate 110.

A second overcoat 250 may be disposed on the light blocking member 220. The second overcoat 250 may be made of an insulating material and may provide a flat surface. The second overcoat 250 can be omitted.

A common electrode 270 may be disposed on the second overcoat 250, and a second alignment layer 22 may be disposed on the common electrode 270.

A polarizer (not shown) may be provided outside each of the first and second display panels 100 and 200. Polarization axes of the two polarizers may be orthogonal, and one of the polarization axes may be parallel with the gate line 121. In the case of the reflective liquid crystal display, one of the two polarizers may be omitted.

By way of summation and review, a color filter may be disposed on a thin film transistor array panel with accurate alignment between the pixel electrode and the color filter. The pixel electrode may be connected to the thin film transistor through a contact hole of the color filter.

The color filter may be manufactured by uniformly applying a coloring photosensitive composition that includes pigments corresponding to red, green, or blue through a coating process, exposing and developing a coating layer formed by primary baking (hereinafter, this may be referred to as heat drying or primary firing), performing secondary baking (hereinafter, this may be referred to as a heat hardening or secondary firing) the coating layer if desired, and repeating the above-noted process for respective colors.

A light exposer may perform the exposing. Digital light exposers for forming fine patterns have been recently developed, new color filters optimized for the digital light exposers are accordingly desirable

Embodiments provide a color filter composition with improved sensitivity for exposure, and a liquid crystal display including the same. According to embodiments, a color filter composition including an initiator and a sensitizer is used to form a color filter, thereby improving the absorption rate of light with the substantial wavelength of 405 nm and controlling the taper angle within the range of 10 to 80 degrees.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope thereof as set forth in the following claims.

What is claimed is:

1. A color filter composition, comprising:
a mill base including a pigment, an initiator, and a solvent,
wherein the initiator is a compound including an oxime group and a light absorbance unit, as expressed in Formula 1: 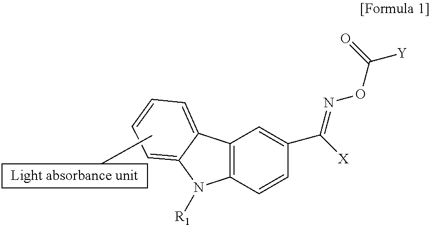
in Formula 1, X, Y, and R₁ are identical to or different from each other and are independently a C1 to C12 alkyl based group or a phenyl based group, and
the light absorbance unit includes at least one of an acetophenone based group, a benzoin based group, a benzophenone based group, and a triazine based group.

2. The color filter composition as claimed in claim 1, wherein:
the light absorbance unit includes the acetophenone based group, and
the acetophenone based group includes at least one of 4-phenoxydichloroacetophenone, 4-t-butyl-dichloroacetophenone, diethoxyacetophenone, 1-(4-isopropyl phenyl)-2-hydroxy-2-methyl propane)-1-one, and 1-hydroxycyclohexyl phenyl ketone.

3. The color filter composition as claimed in claim 1, wherein;
the light absorbance unit includes the benzoin based group, and
the benzoin based group includes at least one of benzoin, benzoin methyl ether, benzoin isopropyl ether, and benzyl dimethyl ketal.

4. The color filter composition as claimed in claim 1, wherein:
the light absorbance unit includes the benzophenone based group, and
the benzophenone based group includes at least one of 4-phenyl benzophenone, hydroxybenzophenone, and 4-benzoyl-4′-methyl diphenyl sulfide.

5. The color filter composition as claimed in claim 1, wherein:
the light absorbance unit includes the triazine based group, and
the triazine based group includes at least one of 2,4,6-trichloro-s-triazine, 2-phenyl-4,6-bis(trichloromethyl)-s-triazine, 2-(p-methoxyphenyl)-4,6-bis(trichloromethyl)-s-triazine, 2-(p-tolyl)-4,6-bis(trichloromethyl)-s-triazine, 2-piperonyl-4,6-bis(trichloromethyl)-s-triazine, 2,4-bis(trichloromethyl)-6-styryl-s-triazine, and 2-(4-methoxy-naphtho-1-yl)-4,2-(naphtho-1-yl)-4,6-bis(trichloromethyl)-s-triazine.

6. The color filter composition as claimed in claim 1, further comprising a sensitizer in an amount of about 0.1 wt % to about 0.9 wt % of the color filter composition,
wherein the sensitizer includes at least one of a benzophenone derivative, a thioxanthone derivative, xanthene, cyanine, thiazine, acridine, an anthraquinone, phenazine, an azo compound, diphenylmethane, triphenylmethane, distyryl benzene, carbazole, porphyrin, a spiro compound, quinacridone, indigo, a styryl compound, a pyrazolo triazole compound, a benzothiazole compound, a barbituric acid derivative, a thiobarbituric acid derivative, acetophenone, and a heterocyclic compound.

7. The color filter composition as claimed in claim 1, further comprising a resin that includes a polymerization inhibiting agent and a storage stabilizing agent.

8. The color filter composition as claimed in claim 7, wherein:
the polymerization inhibiting agent includes at least one of hydroquinone, p-methoxyphenol, di-tert-butyl-p-cresol, pyrogallol, t-butyl catechol, benzoquinone, 4,4′-thiobis(3-methyl-6-t-butylphenol), n-nitroso phenyl hydroxylamine, phenoxazine, phenothiazine, and a cerium (I) salt, and
the storage stabilizing agent includes at least one of benzyl trimethyl chloride, diethyl hydroxyamine hydrochloride, ammonium chloride, lactic acid, oxalic acid, a methyl ester of an organic acid, t-butyl pyrocatechol, tetraethyl phosphine, tetraphenyl phosphine, organic phosphine, and a sub-phosphate.

9. The color filter composition as claimed in claim 1, further comprising a surfactant and an adherence reinforcing agent.

10. The color filter composition as claimed in claim 9, wherein the surfactant includes a fluorine-based surfactant expressed in Formula 2 and a polysiloxane based surfactant expressed in Formula 3: 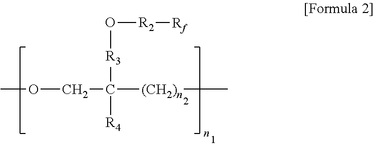
wherein, in Formula 2, R₂ and R₃ are identical to or different from each other and are independently a C1 to C5 alkylene group,
R₄ is a hydrogen atom or a C1 to C5 alkyl group,
R_{f} is a fluorinated C1 to C6 alkyl group,
n₁ is 1 to 50, and n₂ is 0 or 1, and 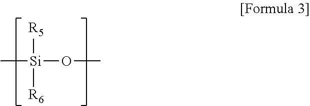
wherein, in Formula 3, R₅ is a straight or branched C1 to C3 alkyl group, and
R₆ is a straight or branched C1 to C15 alkyl group.

11. The color filter composition as claimed in claim 9, wherein the adherence reinforcing agent includes a coupling agent or a melamine crosslinking agent.

12. The color filter composition as claimed in claim 11, wherein:
the adherence reinforcing agent includes the coupling agent, and
the coupling agent includes a vinyl silane coupling agent or an epoxy silane coupling agent.

13. A liquid crystal display, comprising:
a substrate;
a gate line on the substrate, the gate line including a gate electrode;
a gate insulating layer on the gate line;
a semiconductor on the gate insulating layer;
a data line on the semiconductor, the data line including a source electrode;
a drain electrode on the semiconductor, the drain electrode facing the source electrode;
a passivation layer on the gate insulating layer, the data line, and the drain electrode;
a color filter on the passivation layer;
a contact hole on the color filter and the passivation layer, the contact hole exposing the drain electrode; and
a pixel electrode on the color filter, the pixel electrode being connected to the drain electrode through the contact hole,
wherein:
the color filter is formed from a color filter composition including a mill base including a pigment, an initiator, and a solvent, and
the initiator is a compound including an oxime group and a light absorbance unit as expressed in Formula 1: 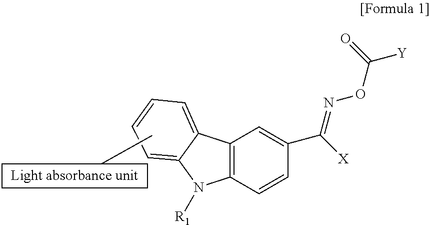
wherein, in Formula 1, X, Y, and R₁ are identical to or different from each other and are independently a C1 to C12 alkyl based group or a phenyl based group, and
the light absorbance unit includes at least one of an acetophenone group, a benzoin group, a benzophenone group, and a triazine based group.

14. The liquid crystal display as claimed in claim 13, wherein the color filter composition further includes a sensitizer in an amount of about 0.1 wt % to about 0.9 wt % of the color filter composition,
wherein the sensitizer includes at least one of a benzophenone derivative, a thioxanthone derivative, xanthene, cyanine, thiazine, acridine, an anthraquinone, phenazine, an azo compound, diphenylmethane, triphenylmethane, distyryl benzene, carbazole, porphyrin, a spiro compound, quinacridone, indigo, a styryl compound, a pyrazolo triazole compound, a benzothiazole compound, a barbituric acid derivative, a thiobarbituric acid derivative, acetophenone, and a heterocyclic compound.

15. The liquid crystal display as claimed in claim 13, wherein:
the color filter composition further includes a resin that includes a polymerization inhibiting agent and a storage stabilizing agent.

16. The liquid crystal display as claimed in claim 15, wherein:
the polymerization inhibiting agent includes at least one of hydroquinone, p-methoxyphenol, di-tert-butyl-p-cresol, pyrogallol, t-butyl catechol, benzoquinone, 4,4′-thiobis(3-methyl-6-t-butylphenol), n-nitroso phenyl hydroxylamine, phenoxazine, phenothiazine, and a cerium (I) salt, and
the storage stabilizing agent includes at least one of benzyl trimethyl chloride, diethyl hydroxyamine hydrochloride, ammonium chloride, lactic acid, oxalic acid, a methyl ester of an organic acid, t-butyl pyrocatechol, tetraethyl phosphine, tetraphenyl phosphine, organic phosphine, and a sub-phosphate.

17. The liquid crystal display as claimed in claim 13, wherein the color filter composition further includes a surfactant and an adherence reinforcing agent

18. The liquid crystal display as claimed in claim 17, wherein the surfactant includes a fluorine-based surfactant expressed in Formula 2 and a polysiloxane based surfactant expressed in Formula 3: 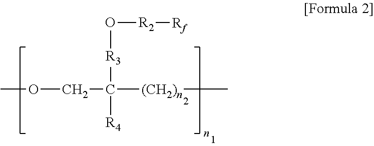
wherein, in Formula 2, R₂ and R₃ are identical to or different from each other and are independently a C1 to C5 alkylene group,
R₄ is a hydrogen atom or a C1 to C5 alkyl group,
R_{f} is a C1 to C6 fluorinated alkyl group,
n₁ is 1 to 50, and n₂ is 0 or 1, and 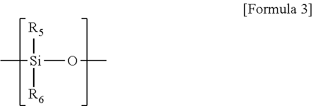
wherein, in Formula 3, R₅ is a straight or branched C1 to C3 alkyl group, and
R₆ is a straight or branched C1 to C15 alkyl group.

19. The liquid crystal display as claimed in claim 18, wherein the adherence reinforcing agent includes a coupling agent or a melamine crosslinking agent.

20. The liquid crystal display as claimed in claim 19, wherein:
the adherence reinforcing agent includes the coupling agent, and
the coupling agent includes a vinyl silane coupling agent or an epoxy silane coupling agent.
